(19) United States
(12) Patent Application Publication
(10) Pub. No.: US 2023/0011682 A1
(43) Pub. Date: Jan. 12, 2023

(54) NETWORK APPARATUS, SYSTEM AND METHOD FOR MONITORING TRANSIENT OCCUPANCY

(71) Applicant: LUXEMBOURG INSTITUTE OF SCIENCE AND TECHNOLOGY, Esch/Alzette (LU)

(72) Inventor: Hoorieh Afkari Roshkhari, Esch/Alzette (LU)

(21) Appl. No.: 17/784,822

(22) PCT Filed: Dec. 8, 2020
(86) PCT No.: PCT/EP2020/085049

§ 371 Date: Jun. 13, 2022

(30) Foreign Application Priority Data
Dec. 20, 2019 (LU) 101563

(51) Int. Cl. G08G 1/14

(52) U.S. Cl. CPC G08G 1/145

(57) ABSTRACT

A networked monitoring apparatus, and a monitoring system and monitoring method based on the apparatus, are disclosed. The apparatus includes at least one sensor, a wireless networking module and a processor operably connected to each other and to a power source, within a housing shielding the apparatus components from environmental conditions, which is attachable to at least one mounting point adjacent a plurality of discrete surface areas. The apparatus periodically monitors each of the discrete surface areas, detects a respective occupancy state thereof by a respective entity with the or each sensor, determines a start and/or end of occupancy state by each respective entity, and communicates respective occupancy state data to at least one remote data processing terminal with the wireless networking module. The monitoring system comprises at least one apparatus in data communication with the remote data processing terminal.

### FIELD OF INVENTION

The present invention relates to a networked apparatus, a system of such apparatuses, and a method of using same, for monitoring transient occupancy of discrete surface areas by entities.

### BACKGROUND TO INVENTION

Logistics science plans and manages the transient occupancy of discrete surface areas, be they individual spaces in car parks, container slots on railcars, packing stations in warehouses, animal pens in farms and the like. Herein, the occupancy of a surface area by an entity refers to the situation of an inert or living entity overlying a non-trivial volume atop a surface for a non-trivial length of time.

In that context, environments which provide a fixed supply of storage area, for example goods storage units, container loading docks and on-street vehicle parking zones, provide increasing challenges because volumes of traded and transported goods continue to increase, likewise levels of vehicle ownership and use.

The monitoring of space occupancy has traditionally been performed manually, by a human attendant visually observing entities in their environment, for example containers lifted onto transit bays or vehicles parked on dedicated spaces, a labour-intensive approach which continues to this day.

In the specific field of vehicle parking management, relatively recent developments are known for automating the monitoring of parking space usage, and which are based on either individual proximity sensors or image frame analysis.

In the first case, illustrated in FIG. 1, a parking unit 10, typically underground, is equipped with overhead gantries 11, one located above each row of spaces 12, to which individual proximity sensor devices 13 are secured, one above each individual space 14. Each device 13 is usually configured with a downward-facing ultrasonic sensor 15, a pilot light 16 visible by drivers circulating nearby, and configurable to emit a green or a red light, depending upon whether the individual space underneath is sensed, respectively, as free or occupied by a car. The device 13 is also connected to a wired data network 17 for communicating the occupancy status of its respective space 14 to a remote terminal or system, which aggregates this occupancy data locally, and may even communicate it to potential users on electronic public signage 18 within the parking unit and/or beyond.

In the second case, illustrated in FIG. 2, another parking unit 20, typically above ground, is equipped with at least one close circuit television camera 21, primarily for security monitoring purposes. A data processing terminal is operably interfaced with the wired CCTV network to which the camera 21 is connected, and processes an image-processing algorithm which repurposes the legacy CCTV video stream. The image-processing algorithm is initially trained with a model of all the individual spaces 14 observable across the parking unit 20 within the camera's field of view, free of any occupancy. The algorithm is then applied to the video stream for detecting the respective occupancy status of individual spaces 14 visible in video frames of the streamed sequence, as either free or occupied, e.g. based on an occlusion approach which compares each individual parking space's ground colour 22 in the model against the current colour 23 at the same location. Again the data processing terminal may simply aggregate this occupancy data for further analysis, but may communicate it to potential users on electronic public signage, within the parking unit and/or beyond.

Notwithstanding the clear advantages of these prior art technique over the absence of any occupancy detection, disadvantages are numerous with either approach. Solutions which monitor individual spaces, as described with reference to FIG. 1, require substantial capital equipment and associated infrastructure, notably in terms of cabling, power supply, trunking for same and a relatively complex web of interoperable data processing means to drive the system.

Optical solutions which monitor groups of individual spaces, as described with reference to FIG. 2, advantageously re-use existing infrastructure with comparably trivial requirements in capital equipment and associated infrastructure, but significantly more complex data processing algorithm(s). Such solutions are moreover liable to commit false positive detections when a substantial portion of a space is covered by snow, leaves or refuse, and further liable to untimely, temporary or permanent disabling if the optical means should become occluded by the elements, when not outright unavailable in the dimmest of light conditions, for example at night.

### SUMMARY OF INVENTION

The invention provides an autonomous and networked apparatus of simple construction for monitoring several adjacent or proximate discrete surface areas, for detecting their transient occupancy by entities over time, and for reporting the detected data as occupancy data to remote terminals or systems. The core characteristics of the apparatus render it inexpensive to manufacture, to site and to operate; moreover easy to network with further apparatuses of the invention, to rapidly build an occupancy monitoring system covering still more discrete surfaces areas and groups thereof that are remote from each other.

According to a first aspect of the invention therefore, there is provided a networked monitoring apparatus, comprising at least one sensor, a wireless networking module, data processing means operably connected to the or each sensor and to the wireless networking module, and configured to periodically monitor each of a plurality of discrete surface areas proximate or adjacent the apparatus and detect a respective occupancy state thereof by a respective entity with the or each sensor, to determine a start and/or end of occupancy state by each respective entity, and to communicate respective occupancy state data to at least one remote data processing terminal with the wireless networking module, a power source operably connected to the data processing means, the wireless networking module and the or each sensor, and a housing for shielding the wireless networking module, the or each sensor, the data processing means and the power source from environmental conditions, attachable to at least one mounting point adjacent the plurality of discrete surface areas.

In an embodiment of the apparatus, the at least one sensor is may be secured to an oscillating mechanism, wherein the data processing means is further operably connected to the oscillating mechanism and further configured to control an oscillating frequency and/or angular speed thereof.

The oscillating mechanism advantageously reduces the number of sensors required to monitor the discrete surface areas, which are all sensed periodically as the mechanism shifts the sensor aperture over time, and so reduces the power requirements of the apparatus to perform the detecting.

In an alternative embodiment of the apparatus, a plurality of sensors may be arranged in an array within the housing, wherein the data processing means is further operably connected to the array and further configured to control a monitoring aperture thereof.

The array of sensors advantageously removes mechanical points of operational failure associated with a mechanism physically displacing sensor(s), whilst maintaining the periodicity of monitoring across several distinct surface areas by switching individual sensors in the array, each with a respective sensing aperture. The monitoring aperture of the apparatus corresponding to the whole array is effectively displaced over time, identically to an embodiment with fewer sensor(s) secured to a mechanism.

In either embodiment, the control performed by the data processing means can be permanent and/or dynamic, with configurations balancing or alternating power efficiency, calling for a least frequent rate of detection, with occupancy data accuracy calling for a most frequent rate of detection, according to one or more variables such as the power level available from the power source, the time of day, anticipated patterns of occupancy and more.

In an embodiment, the at least one remote data processing terminal, to which respective occupancy state data is communicated by the apparatus, may be another apparatus according to this first aspect of the invention. This configuration advantageously permits an apparatus to receive occupancy data from another, for example a most proximate further apparatus, and to both relay this received occupancy data and communicate its own local occupancy data to a remote data processing terminal aggregating the respective occupancy data of two sets of discrete surface areas. A mesh of networked apparatuses can thus be formed, each apparatus communicating respective occupancy data to a neighbouring apparatus at relatively short range and least power consumption, with the apparatus nearest a non-apparatus terminal relaying the occupancy data from the entire mesh.

Embodiments of the apparatus are considered, wherein the or each sensor is selected from the group comprising ultrasonic, infrared, microwave and optical sensors. In embodiments of the apparatus comprising a plurality sensors, each sensor, as selected from the group comprising ultrasonic, infrared, microwave and optical sensors, may be of a different type relative to the or each other.

In an embodiment of the apparatus, the data processing means may be further configured to detect, with the or each sensor, a size and/or shape of the entity occupying a respective discrete surface area.

In a preferred embodiment, the detecting is both distance-based and time-stamped, thus relying upon at least one ultrasonic sensor, and the occupancy data comprises a shape of the detected entity and time data.

Embodiments of the apparatus are considered, wherein at least one detectable characteristic of entities is user-selectable, and wherein the data processing means may then be further configured to receive, through the wireless module, the or each detectable characteristic as a monitoring parameter.

The selectivity of entity characteristics and their use for configuring the monitoring performed by the apparatus advantageously allows a user to repurpose the apparatus ad hoc for obtaining occupancy data of a same set of discrete surface areas by various types of entities, over defined and/or respective time periods. A practical example may involve selecting a detectable characteristic of an entity such as its size which, in the case of vehicles, permits a clear distinction between a personal vehicle and a typically larger goods transport vehicle, and wherein the granularity of detected occupancy data can be enhanced with vehicle type. Another practical example may involve selecting a detectable characteristic of an entity such as its shape which, in the case of containers, permits a clear distinction between rectangle prismatic containers and cylindrical containers, and wherein the granularity of detected occupancy data can be enhanced with container type.

Alternative or complementary embodiments of the apparatus are considered, wherein a parameter of each discrete surface area is user-selectable, and wherein the data processing means may then be further configured to receive, through the wireless module, the or each parameter from the remote data processing terminal as a monitoring parameter.

The selectivity of discrete surface area parameters and their use for configuring the monitoring performed by the apparatus advantageously allows a user to repurpose and/or redefine the total area under monitoring, comprised of the initial set of discrete surface areas, into an alternative set of different discrete surface areas, for obtaining occupancy data of that alternative set of discrete surface areas by various types of entities, over defined and/or respective time periods. Given an initial length of discrete surface area suited for a first entity type, e.g. a parking space on a public pathway sized for a personal vehicle, a practical example may involve selecting a second longer length of discrete surface area suited for a second entity type, e.g. a parking space on a public pathway sized for a longer goods transport vehicle, wherein the second length corresponds to e.g. thrice the first length, thus wherein the apparatus monitoring the occupancy of an initial set of three discrete surface areas, is repurposed to monitor the occupancy of a single discrete surface area occupying the same total area as the initial set.

A combination of the above two embodiments may advantageously provide a vehicle parking monitoring solution for parking spaces with alternate use according to any chronological-, regulatory- or mobility-optimising basis, e.g. vehicle parking areas alternatively dedicated to personal vehicles or to goods transport vehicles according to the time of day or night; likewise railcars (“well cars”) alternatively accommodating 20- or 40-feet intermodal containers, in single our double stacks.

Embodiments of the apparatus are considered, wherein the power source may be selected from the group comprising a connection to a mains power supply, a rechargeable battery operably connected to a mains power supply, and a rechargeable battery operably connected to solar energy or wind energy capturing means secured to, or adjacent, the housing. All embodiments of the apparatus should be capable of autonomous operation, irrespective of the power source.

According to another aspect of the invention, there is also provided a distributed surface monitoring system, comprising at least one networked monitoring apparatus as described herein and located adjacent a first plurality of discrete surface areas, optionally comprising a second such networked monitoring apparatus located adjacent a second plurality of discrete surface areas, and comprising at least one data processing terminal remote from the or each apparatus and operably in data communication therewith across at least one network.

The system of the invention advantageously provides for the remote monitoring of at least one set of discrete surface areas with an apparatus according to the first aspect of the invention, by the data processing terminal, which will be typically operated by a party having operational and/or regulatory control of the surface corresponding to the set, for example a town hall in a small settlement with a single sets car parking spaces, scaling up to, with additional apparatuses, vehicle management authorities of large conurbations.

An embodiment of the system may further comprise storing means for storing a model of the first and optionally second discrete surface areas, and geolocating means for associating occupancy state data that is received from the one or more apparatuses with each discrete surface area in the model, substantially in real-time.

The model need not be computationally complex, and modelling each discrete surface area therein may simply consist of the lowest amount of data required to identify it uniquely, relative to all other adjacent and remote discrete surface areas monitored in the system. Depending on the embodiment, this may consist of the lowest amount of data required to geolocate each discrete surface area. The geolocating facilitates the association of actual occupancy data of each physical discrete surface area with its modelled equivalent, to build a historical and geolocated record of discrete surface area occupancy, besides indicating geolocated occupancy capacity across the total area of discrete surface areas monitored by the system in real-time.

In a variant of this embodiment, the geolocating means may further receive, process and respond with detected occupancy state data, to a data request from a user terminal that is remote from the one or more apparatuses and data processing terminals and that is in at least ad hoc data communication therewith across the network or another.

This embodiment advantageously meets logistical planning requirements of individual users provided with ad hoc access to the occupancy data stored by the system, e.g. in a vehicle parking embodiment, vehicle drivers connecting to the system with personal communication devices and querying the system in real-time about the occupancy status of geo-located parking spaces.

In a further variant, the geolocating means may be further configured to respond to the data request with geographical data representative of at least one discrete surface area, that is available for occupancy according to its occupancy state data at the time of processing the user terminal data request.

This further embodiment meets forward logistical planning requirements of individual users still better, e.g. in the vehicle parking embodiment, vehicle drivers may connect to the system with personal communication devices and query the system in real-time about the availability of geo-located parking spaces for occupancy likewise in real-time.

In yet another variant, the or each user terminal may be configured to input a detectable characteristic of an entity and/or a parameter of a discrete surface area, and to include this input in the data request, and the geolocating means may be further configured to match the input with a parameter of one or more discrete surface areas.

This further embodiment meets forward planning needs of individual users still more precisely, e.g. in the vehicle parking embodiment, vehicle drivers may connect to the system with personal communication devices and query the system in real-time about the availability of geo-located parking spaces for occupancy according to their vehicle size or to the size of parking space required for same.

Embodiments of the system are considered, wherein the storing means may further store occupancy state data of the first and optionally second discrete surface areas, the system further comprising analysing means for processing the stored and associated occupancy state data, to detect patterns of occupancy state across discrete surface areas in the model over time and to predict occupancy states of discrete surface areas based on detected patterns.

The analysing means may be a machine-learning algorithm or its functional equivalent, processed by the one or more data processing terminal(s) aggregating occupancy data detected by each apparatus in the system, and supplied with the model and the historical and geolocated record of discrete surface area occupancy as an input. The machine-learning algorithm is then trained to determine patterns of occupancy of discrete surface areas across the total area of discrete surface areas monitored by the system.

In a variant of this embodiment, the geolocating means may be further configured to respond to the data request with geographical data representative of at least one discrete surface area, that is predicted to become available for occupancy according to its predicted occupancy state data.

This further embodiment contributes to optimising the mobility of entities both within the geographical area corresponding to the total area of discrete surface areas monitored by the system, and travelling towards that geographical area. For example, in the vehicle parking embodiment, vehicle drivers connecting to the system with personal communication devices and querying the system in real-time about the availability of geo-located parking spaces for occupancy, obtain a broader choice of destination parking spaces, with the real-time data corresponding to spaces currently unoccupied augmented with predictive data corresponding to spaces forecast to be unoccupied by the time of arrival thereat.

Embodiments of the system are considered, wherein one or more apparatuses comprise the storing means, the geolocating means, and optionally the analysing means. Adverting to a preference for apparatuses in the system to operate substantially autonomously, both for ease of system configuration and for resiliency of system operation, the storing, geolocating and optionally analysing functions of the system may be distributed across the respective data processing means of all apparatuses across the total area of discrete surface areas monitored by the system, for instance based on a self-organising, peer-to-peer network architecture, wherein the output data of the collectivised processing is still communicated to at least one data processing terminal interfacing the system with third party networks and devices.

Alternative embodiments of the system are considered, wherein the data processing terminal remote from the one or more apparatuses comprises the storing means, the geolocating means, and optionally the analysing means, such embodiments relieving the data processing means of monitoring apparatuses in the system from computationally-expensive data processing tasks, thereby maintaining low energy consumption at each monitoring apparatus.

Embodiments of the system are considered, wherein one or more apparatuses comprise the geolocating means, and the data processing terminal remote from the one or more apparatuses comprises the storing means, and optionally the analysing means, such embodiments usefully providing a load-balancing approach to distributing data processing between apparatuses and the one or more data processing terminals, for instance when the depleting power resource of an apparatus in the system reaches a predetermined threshold of power available from its local source.

According to a further aspect of the invention, there is also provided a method of monitoring parking surface occupancy by vehicles, comprising the steps of locating at least a first apparatus comprising a networking module and at least one sensor proximate or adjacent a first plurality of parking spaces; periodically monitoring each parking space with the sensor and detecting a respective occupancy state of each parking space by a respective vehicle; determining a start and/or end of occupancy state by each respective vehicle; establishing a first network connection between the at least first apparatus and at least one remote data processing terminal with the networking module; and communicating occupancy state data to the or each remote data processing terminal.

An embodiment of the method may comprise the further step of locating a second apparatus comprising a networking module and at least one sensor proximate or adjacent a second plurality of parking spaces. In variants of this embodiment, the first and second plurality of parking spaces may be contiguous with one another, or on opposed sides of a pathway.

An embodiment of the method may comprise the further step of establishing a data communication link between the first and second apparatuses, either over the first network connection or over a second ad hoc network connection.

An embodiment of the method may comprise the further step of securing the sensor to an oscillating mechanism, wherein the step of monitoring further comprises subjecting the mechanism to an oscillating frequency.

An embodiment of the method may comprise the further step of providing an array of sensors defining a detecting aperture in the first and/or second apparatus, wherein the step of monitoring further comprises selectively switching each sensor along the detecting aperture.

In variants of these embodiments, the step of monitoring may further comprise controlling a frequency of mechanism oscillation, alternatively a frequency of sensor switching, according to one or more selected from the group comprising a chronological parameter, an environmental parameter and an operational parameter of the first apparatus.

Embodiments of the method are considered, wherein the or each sensor is one selected from the group comprising ultrasonic, infrared, microwave and optical sensors, whereby the step of monitoring further comprises scanning each parking space with an ultrasonic, infrared, microwave and/or optical sensor.

Embodiments of the method are considered, wherein the step of detecting further comprises detecting a start time and/or an end time of occupancy of each parking space by a respective vehicle, and calculating a corresponding and respective duration of occupancy for each vehicle.

Embodiments of the method are considered, wherein the step of detecting further comprises detecting a size and/or shape of the vehicle occupying a respective parking space.

An embodiment of the method may comprise the further steps of selecting a detectable vehicle characteristic either at the data processing terminal or at a user terminal remote therefrom; communicating the selected detectable vehicle characteristic to the or each apparatus; and setting the selected detectable vehicle characteristic as a monitoring parameter.

An embodiment of the method may comprise the further steps of selecting a parameter of a or each parking space either at the data processing terminal or at a user terminal remote therefrom; communicating the selected parking space parameter to the or each apparatus; and setting the selected parking space parameter as a monitoring parameter.

A variant of either of the two embodiments last introduced above, may comprise the further steps of receiving a data request from the data processing terminal or the user terminal, the data request including a detectable vehicle characteristic, alternatively a parking space parameter; matching the data request with detected occupancy state data; and responding to the data processing terminal or the user terminal request with the matched occupancy state data.

An embodiment of the method may comprise the further steps of storing a model of the first, optionally and of a second, plurality of parking spaces; and geo-locating occupancy state data that is received from the first, optionally from the second, apparatus with the corresponding parking space in the model, substantially in real time.

In a variant of these embodiments, the step of responding may further comprise responding to the data processing terminal or the user terminal request with geographical data representative of at least one parking space corresponding to the matched occupancy state data.

An alternative variant of these embodiments may comprise the further steps of storing occupancy state data of the first, optionally and of a second, plurality of parking spaces; detecting patterns of occupancy state across parking spaces in the model over time; and predicting occupancy states of parking space based on detected patterns. With reference to embodiments processing terminal or user device requests, the step of responding may further comprise responding to the data processing terminal or the user terminal request with geographical data representative of at least one parking space that is predicted to become available for occupancy according to its predicted occupancy state data.

According to yet another aspect of the invention, there is also provided a vehicle parking unit comprising a plurality of discrete parking surface areas, configured with at least one networked monitoring apparatus according to the first aspect of the invention, or configured with a distributed surface monitoring system according to according to the second aspect of the invention.

Other aspects of the present invention are as stated in the appended claims.

### BRIEF DESCRIPTION OF DRAWINGS

Embodiments of the present invention will now be described by way of example only, with reference to accompanying drawings, wherein:

FIG. 1 illustrates a first vehicle parking unit, equipped with individual parking space occupancy sensors of the prior art;

FIG. 2 illustrates the first vehicle parking unit, equipped with an optical occupancy detection system of the prior art;

FIG. 3 illustrates the first vehicle parking unit, equipped with a networked monitoring apparatus according to a first embodiment of the invention;

FIG. 4 is a bloc diagram of the networked monitoring apparatus of FIG. 3, including a sensor, data processing means and memory means;

FIG. 5 details a monitoring aperture of the apparatus of FIGS. 3 and 4;

FIG. 6 illustrates the first vehicle parking unit, equipped with a networked monitoring apparatus according to a second embodiment of the invention;

FIG. 7 is a bloc diagram of the networked monitoring apparatus of FIG. 6, including an array of sensors, data processing means and memory means;

FIG. 8 details a monitoring aperture of the apparatus of FIGS. 6 and 7;

FIG. 9 illustrates steps of a data processing method performed by the data processing means shown in FIGS. 4 to 9 at runtime, according to a first embodiment of the invention;

FIG. 10 is a logical diagram of the contents of the memory means shown in FIG. 4 or 7 at runtime, whilst performing the steps of FIG. 9;

FIG. 11 illustrates first and second vehicle parking units equipped with respective networked monitoring apparatuses as shown in FIGS. 4 to 9, that are operably connected with a remote data processing terminal to define, collectively, a monitoring system according to an embodiment of the invention.

FIG. 12 is a bloc diagram of the data processing terminal of FIG. 11, including data processing means and memory means;

FIG. 13 illustrates steps of a data processing method performed by the data processing means shown in FIG. 12 at runtime, according to an embodiment of the invention;

FIG. 14 is a logical diagram of the contents of the memory means shown in FIG. 12 at runtime, whilst performing the steps of FIG. 13;

FIG. 15 shows a second embodiment of the monitoring system of FIGS. 11 to 14, wherein detected occupancy data is stored and geolocated;

FIG. 16 shows a further embodiment of the monitoring system of FIG. 11 to 14 or 15, wherein detected, optinally stored and geolocated, occupancy data is distributed to requesting user devices;

FIG. 17 shows a further embodiment of the monitoring system, wherein the monitoring is parameterised, either with a discrete surface area parameter and/or with a detectable entity characteristic, and either at the remote data processing terminal or at a user device;

FIG. 18 shows a further embodiment of the monitoring system, wherein stored occupancy data is processed for pattern detection, then distributed to requesting user devices.

### DETAILED DESCRIPTION OF DRAWINGS

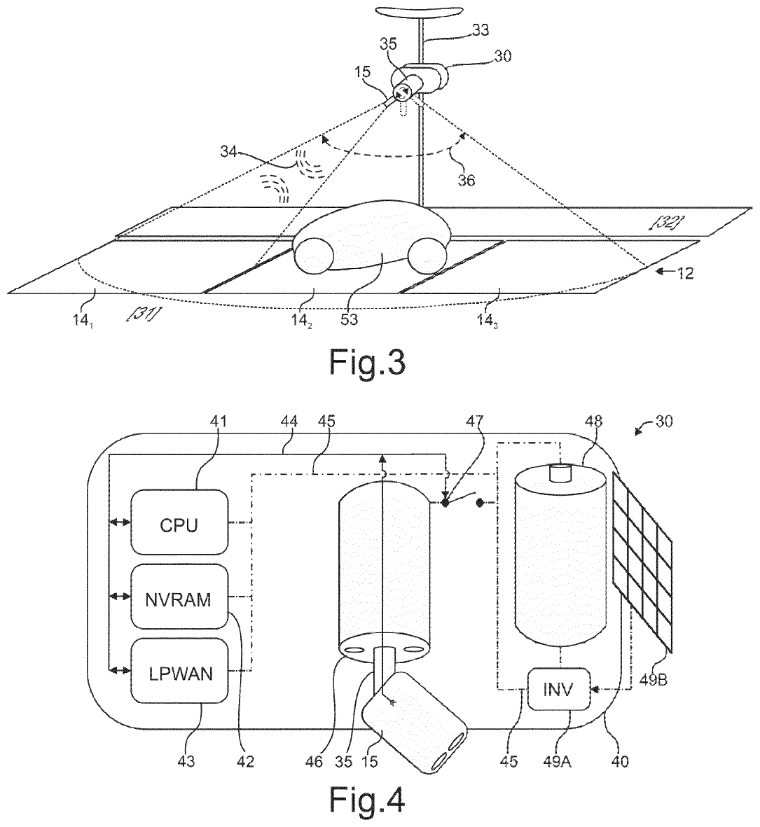

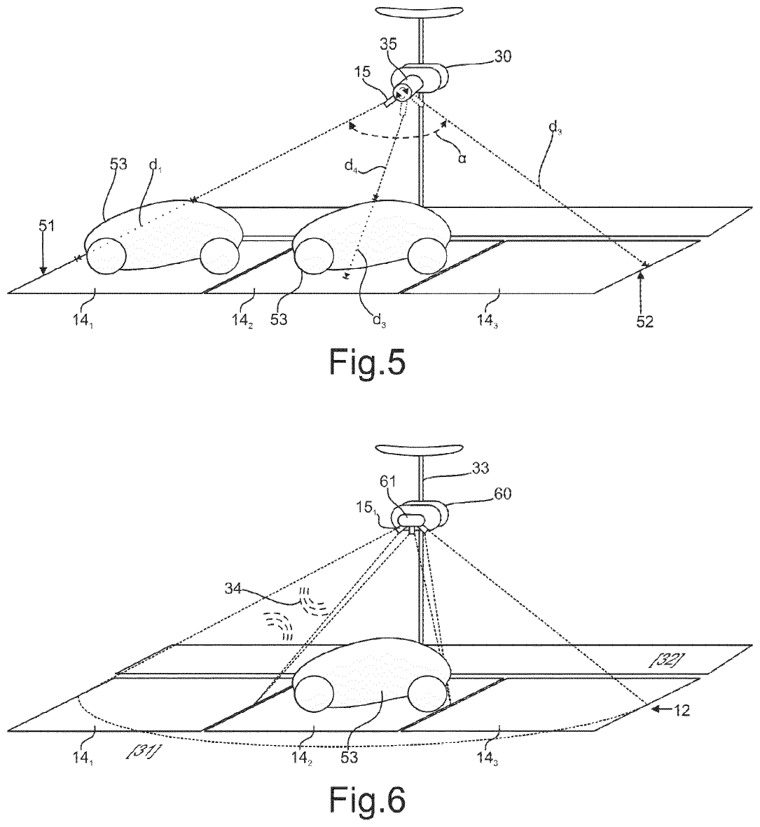

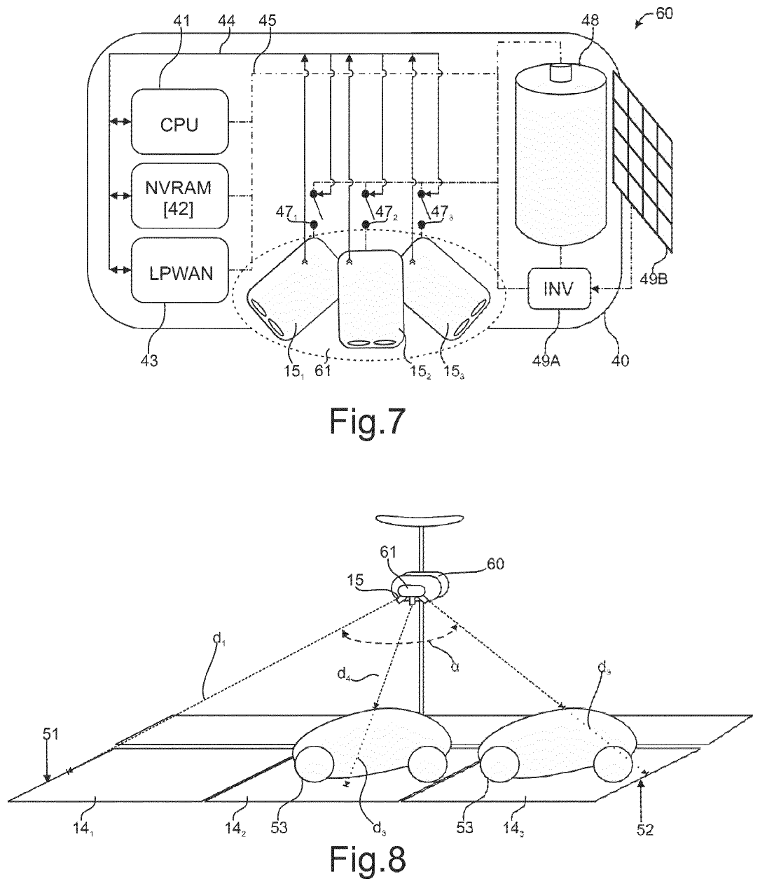

Embodiments of the invention will now be described by reference to FIGS. 3 to 19 herein, as non-limitative examples of how the inventive principles disclosed herein may be practiced by the skilled person, wherein like numerals refer to like features across the Figures. Embodiments are all described with reference to a vehicle parking applicative context, for the sake of simplicity and expected familiarity of the skilled reader with this well-known operational environment, but the skilled person will easily understand from the foregoing, how the inventive principles disclosed herein may be practiced in respect of alternative applicative contexts, for example goods logistics, large scale farming and more.

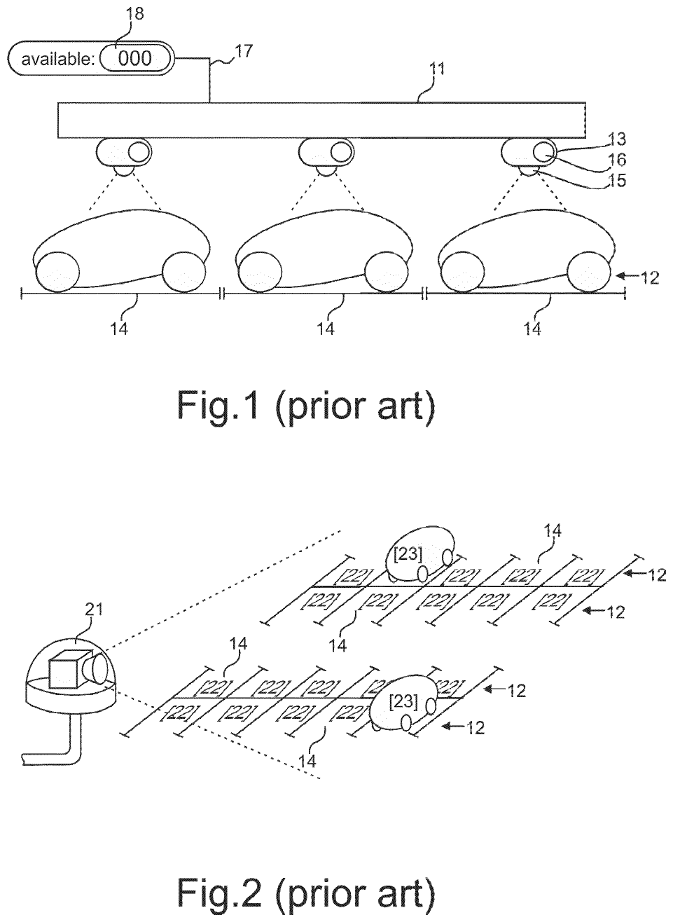

A first embodiment of an autonomous and networked apparatus 30 according to the invention is shown in FIGS. 3 to 5, which is located adjacent the vehicle parking unit 10 first described with reference to FIGS. 1 and 2. In the example, the vehicle parking unit 10 comprises a row 12 of three on-street car parking spaces 14₁, 14₂, 14₃ as a reserved section of a public highway 31 in a street. The environment further includes a pavement section 32 alongside the public highway 31 and a street lighting fixture 33 extending upwardly from the pavement section 32, which is located substantially mid-section of the intermediate parking space 14₂ in the row 12. It will be easily understood by the skilled reader from the present description, however, that the topology of the surface under monitoring not limited to any particular type, shape or size.

In the example environment, the apparatus 30 is secured to the street fixture 33 at a level substantially proximate an end of the fixture distal the pavement 32. The apparatus 30 comprises a single sensor 15, in the example an ultrasonic sensor apt to measure a distance between itself and any surface which reflects its sound waves 34 back to the sensor. The sensor 15 is mounted to a first end of an oscillating arm 35 of the apparatus 30, which periodically translates the sensor along an arcuate trajectory having a plane substantially parallel to the fixture 33 and perpendicular to the row of on-street car parking spaces 14₁-14₃. The aperture of the sensor 15 thus emits sound waves towards each of the car parking spaces 14₁-14₃ over the period of time required to traverse the oscillating arm along the full length of its operational arc 36.

The sensor 15 and at least a portion of the oscillating arm 35 project from a front portion of a housing 40 of the networked monitoring apparatus 30, whilst further components of the apparatus are housed therein to shield them from environmental wear and tear. Such further components include a microprocessor 41, for example a single-board microcontroller conforming to the Arduino™ open-source architecture, a non-volatile memory module 42 which may form part of the microcontroller board 41, and a low power wide area network (LPWAN) wireless module 43, for example a micromodule of the ‘CMWX1ZZABZ’ range manufactured and distributed by Murata Manufacturing Co, Ltd of Kyoto, Japan and conforming to the LoRaWAN™ open networking standard, wherein the microprocessor 41, the memory 42 and LPWAN module 43 are interfaced with an input-output data bus 44 and a power supply bus 45.

The apparatus components further include a low power electric motor 46 having a rotating shaft mated to the arm 35 for oscillating same, a power input connected to the power supply bus 45, and an internal or external switch 47 connected to the I/O bus 44 for receiving control commands from the microprocessor 41. A rechargeable battery 48 is connected to the power supply bus 45, having a power storage capacity sufficient to power all components 15, 41, 42, 43, 46 over the minimum period desirable for autonomous operation of the appartus 30. The power supply bus 45 is further connected to an inverter module 49A interfacing same with solar panels 49B mounted on a top surface of the housing 40, the inverter module being further connected to the I/O bus 44 for receiving control commands from the microprocessor 41 to switch input supply to the power bus 45 between the solar source 49B and the battery 48, which is recharged during solar source-powered operation of the apparatus 30.

In use, after securing the apparatus 30 to the street fixture 33, the apparatus is initially calibrated relative to each of the three discrete surface areas 14₁, 14₂, 14₃ to monitor, that are unoccupied at the time. At a minimum, the calibration includes a detection of the longest distances d₁, d₂ between the sensor 15 and the respective end surface 51, 52 of parking spaces 14₁, 14₃ one most distal the other along the row 12, i.e. each most distal the apparatus 30 on either side of it, and the shortest distance d₃ between the sensor 15 and the surface area of the intermediate parking space 14₂ most proximate, directly underneath the apparatus 30. The longest distances d₁, d₂ thus correspond to respective and opposed extremities of the total aperture of the apparatus 30, i.e. the arcuate trajectory of the sensor 15 on the oscillating arm 35 between predefined stops of the motor shaft course that define a generally acute angle a.

The distances d₁, d₂, d₃ constitute the minimum calibration data required from local detection, as respective occupancy data for each of the three parking spaces 14₁₋₃ can be computed by the microprocessor 41 based on distance data detected by the sensor 15 in use: when a vehicle 53 parks into one of the 3 discrete parking spaces 14₁₋₃, in the example the middle parking space 14₂, then depending upon the sampling rate of the sensor 15, one or more distances d₄-d_{N} is or are detected, based on sound waves reflected by the body of the vehicle 53, as the sensor 15 follows its arcuate trajectory. Each such detected distance d₄-d_{N} is less than the reference calibrated distances d₁-d₃ and thus is representative of occupancy of a discrete surface area by a vehicle 53. However, in the absence of further vehicles occupying the end parking spaces 14₁, 14₃ on either side of the middle vehicle 53, wherein each such further vehicle would occlude the line of the sight of the sensor 15 towards the respective end surface(s) 51, 52 of parking space(s) 14₁, 14₃, the longest distances d₁, d₂ both remain detectable by the sensor 15, representative of non-occupancy of the discrete surface areas 14₁, 14₃.

Further calibration data is preferably stored in the memory 42 for the microprocessor 41 and usefully comprises a tolerance threshold applied to the detected reference distances d₁, d₂, d₃, that corresponds to a height of material which may temporarily overlay the surface of one or more of the monitored parking spaces due to environmental conditions, so as to inhibit a false-positive detection of occupancy when such material begins to accumulate over the base reference surface. Such material may for example include snow, fallen leaves, flood water, or refuse, and the threshold value is preferably set to correspond to a maximum height of such material, over which a vehicle 53 may still drive and park onto a parking space 14, for example by reference to an average vehicle chassis clearance value.

The skilled reader will readily understand from the above tolerance threshold principle, how the apparatus of the invention may be used as an automated surface maintenance and/or flood alerting apparatus, in parallel to its primary task of monitoring surface occupancy, by configuring the microprocessor 41 to communicate an alert through the LPWLAN module 43 to a remote terminal or other device, whenever a distance d_{N} detected intermediate the sensor 15 arc, and so co-axially with the shortest reference distance d3, exceeds the tolerance threshold value, however by less than a second threshold value corresponding to a minimum height representative of an upper vehicle body surface.

Further calibration data may usefully comprise an oscillation rate and/or an angular speed setting for controlling the actuation of the motor 46. The oscillation rate relates to the frequency of travel of the arm 35 along the arcuate trajectory imparted to it by the motor shaft, whilst the angular speed relates to the speed at which the arm 35 translates along that arcuate trajectory. Either or both of the oscillation rate and the angular speed may be constant, or may be varied according to one or more factors including a detected level of power supply, a power storage level of the rechargeable battery 48 during battery operation, a time of day or other chronological referencing factor, any may further be varied dynamically as values representative of such factors change, e.g. the oscillation rate and/or the angular speed may be decreased in proportion to depletion of the battery power storage, scheduled horological or calendar events and more.

Generally, the details of the sensor scanning state at any one time are defined in a default monitoring configuration described hereafter, which is stored in the memory 42 and comprises default operational parameters for the sensor and associated oscillating mechanism. Such parameters may be defined either at the time of installing the apparatus 30 adjacent the row of parking spaces 14 and/or at the calibration phase, based on any one or more of the geometry and other characteristics of the surface, anticipated occupancy frequency, occupancy by vehicle type and more.

With reference to FIGS. 6 to 8 now, a second embodiment of an autonomous and networked apparatus 60 according to the invention is shown, located adjacent the same vehicle parking unit 10 described with reference to FIGS. 1 to 5. The apparatus 60 comprises components substantially as described with reference to FIG. 4, however without a motor 46 and an oscillating arm 35. Instead, this embodiment of the apparatus 60 comprises three sensors 15₁₋₃ arranged in an array 61, in the example three ultrasonic sensors each apt to measure a distance between itself and any surface which reflects its respective sound waves 34 back to it.

The array 61 is mounted to, or forms part of, a front face of the housing 40 of the apparatus 60, with the three sensors thereof arranged one next to the other, at an angle one offset relative to the other and facing substantially downwardly, having a plane substantially parallel to the fixture 33 and perpendicular to the row of on-street car parking spaces 14₁-14₃, so that their respective sound wave-emitting and -receiving apertures collectively define an arcuate aperture for the array, extending between the most distal detection range of each of the two sensors 15₁₋₃ bracketing the middle sensor 15₂, without overlapping each other.

The array 61 is again operably interfaced with the microcontroller 41 through the input-output bus 44 and an individual switch 47₁₋₃ for each sensor 15₁₋₃ that allows selective switching on and off of each sensor independently of the other two. In this embodiment, rather than periodically translate a single sensor 15 along an arcuate trajectory to monitor the row 12 of parking spaces 14₁₋₃, each sensor 15₁₋₃ in the array 61 is periodically switched on to emit sound waves towards the car parking space 14₁₃ which its respective aperture faces, wherein switching all three sensors iteratively over a period of time effectively monitors the full set of discrete parking spaces 14₁₋₃ within the array's combined monitoring aperture.

In use, after securing the apparatus 60 to the street fixture 33, the apparatus is initially calibrated relative to each of the three discrete surface areas 14₁, 14₂, 14₃ to monitor, that are unoccupied at the time. In this embodiment, the calibration includes a detection of the longest respective distance d₁, d₂ between each the two sensors 15₁,₃ bracketing the intermediate sensor 15₂, and the respective end surface 51, 52 of the two parking spaces 14₁₋₃ one most distal the other along the row 12.The longest distances d₁, d₂ thus again correspond to respective and opposed extremities of the total aperture of the array 61 of the apparatus 60, i.e. the combined aperture of the three sensors 15₁₋₃ that define substantially the same acute angle a.

The distances d₁, d₂, d₃ again constitute the minimum calibration data required from local detection, as respective occupancy data for each of the three parking spaces 14₁₋₃ can be computed by the microprocessor 41 based on distance data detected by each sensor 15₁₋₃ in turn, in use: when a vehicle 53 parks into one of the 3 discrete parking spaces 14₁₋₃, in the example the middle parking space 14₂, then depending upon the switching and sampling rates of the sensors 15₁₋₃, one or more distances d₄-d_{N} is or are detected, based on sound waves reflected by the body of the vehicle 53, as the sensors 15₁₋₃ are sequentially switched.

Each such detected distance d₄-d_{N} is less than the reference calibrated distances d₁-d₃ and thus is representative of occupancy of a discrete surface area by a vehicle 53. However, in the absence of further vehicles occupying the end parking spaces 14₁, 14₃ on either side of the middle vehicle 53, wherein each such further vehicle would occlude the line of the sight of the lateral sensors 15₁, 15₃ towards the respective end surface(s) 51, 52 of parking space(s) 14₁, 14₃, the longest distances d₁, d₂ both remain detectable by their respective sensor 15₁, 15₃, representative of non-occupancy of the discrete surface areas 14₁, 14₃.

Further calibration data may again be stored in the memory 42 for the microprocessor 41, which may comprises the tolerance threshold applied to the detected reference distances d₁, d₂, d₃, optionally a second threshold value corresponding to a minimum height representative of an upper vehicle body surface, and in this embodiment, a sensor switching rate which may again be constant, or varied according to one or more factors.

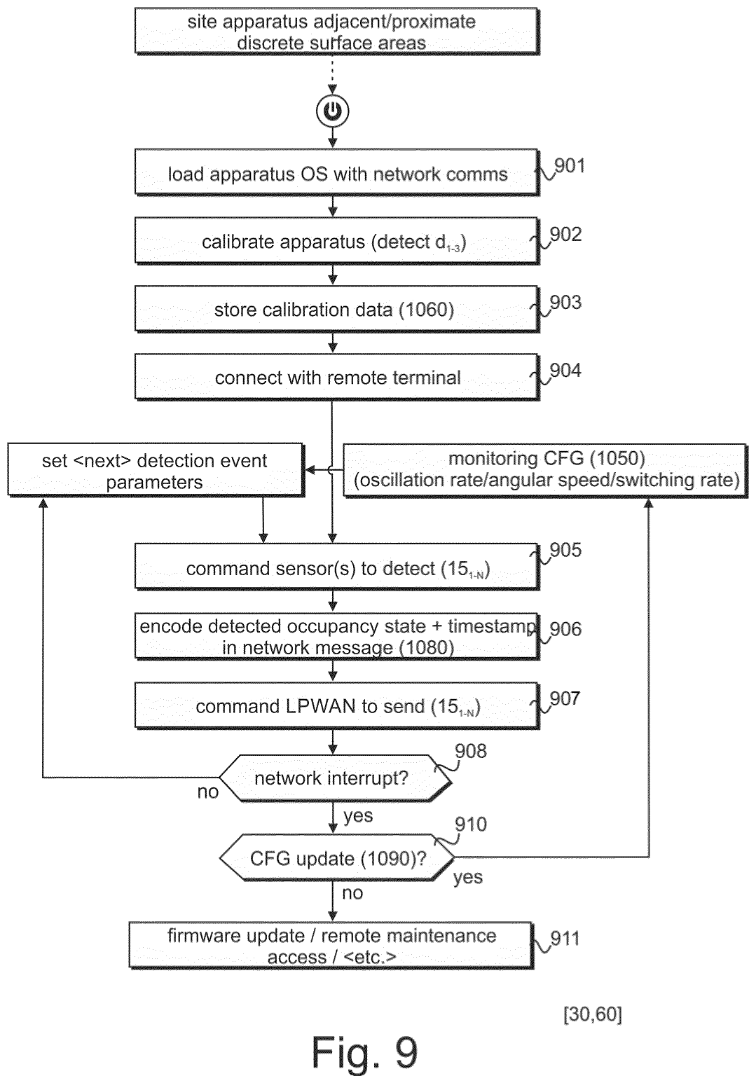

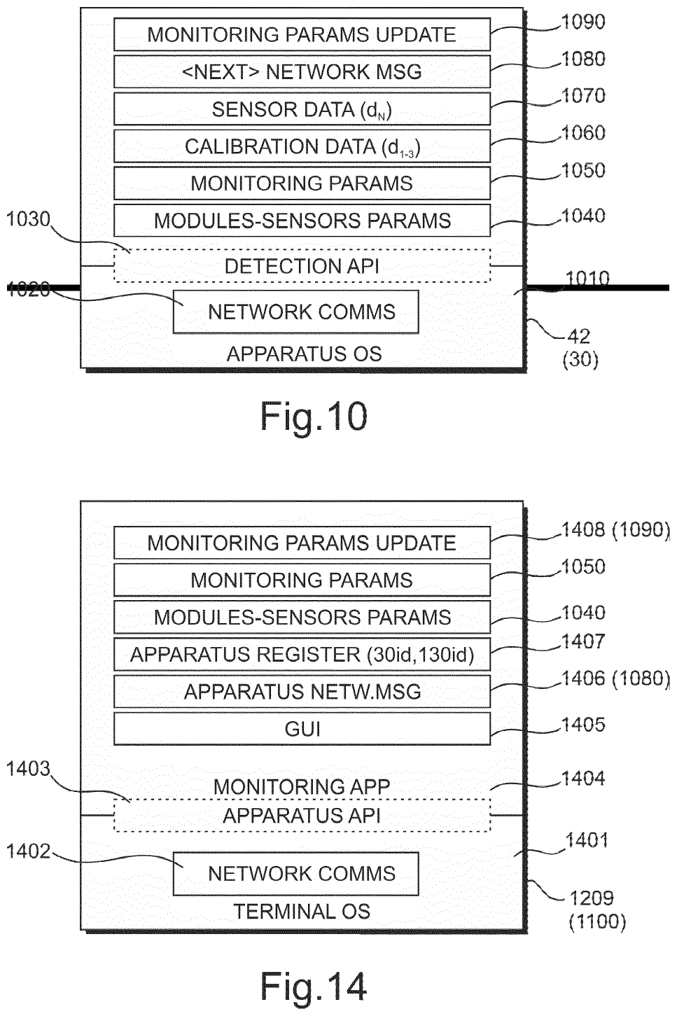

The data processing method performed by the microcontroller 41 at runtime in accordance with the above principles, is now described by reference to FIGS. 9 and 10. Further to siting the apparatus 30 or 60 proximate or adjacent the parking unit 10, for instance by securing same to the street light fixture 33 of the example, the apparatus is first started at step 901, wherein an operating system (‘OS’) 1010 is loaded in the memory 42, including a set 1020 of network subroutines for controlling and communicating data through the LPWAN module 43. The startup step further loads one or more Application Programmer Interface(s) (‘API’) 1030 for controlling and receiving data from the sensor(s) 15 and controlling the actuation of switch(es) 47; standard operational parameter data 1040 for the onboard LPWAN 43, the one or more sensor(s) 15(₁₋₃) and the one or more switch(es) 47(₁₋₃); and default monitoring configuration data 1050 including one or more oscillation rate(s) and one or more angular speed value(s) for the oscillating arm 35, one ore more sensor switching rate(s) for the array 61, and detection threshold values.

At step 902, the microcontroller 41 performs a calibration routine through the one or more sensor(s) 15(₁₋₃) to first detect the discrete surface areas 14₁₋₃, in this example the maximum aperture of the apparatus 30 delimited by the longest distances d₁, d₂ and the median aperture denoted by the shortest distance d₃.

The microcontroller 41 then stores this detected calibration data as monitoring calibration parameters 1060 at step 903. At step 904, the microcontroller 41 instructs the LPWAN module 43 to establish a networked data connection with at least one remote data processing terminal, for communicating detected occupancy data thereto according to the invention, and examples of the terminal and connection will be further described with reference to FIGS. 11 to 14.

At step 905, the microcontroller 41 commands the one or more sensor(s) 15(₁₋₃) to next detect the discrete surface areas 14₁₋₃ for occupancy, based on the monitoring calibration parameters 1060. Step 905 may be implemented in many different ways, depending upon the processing power of the microcontroller 41, the amount of memory available in the meory 42, the mechanical or switched type of periodical detection permitted by the embodiment, a desired or resource-optimised sampling rate or monitoring periodicity of the apparatus 30 encoded in the default monitoring configuration data 1050, and more.

In a simple embodiment, at step 905 the microcontroller 41 receives a detected distance d_{N} 1070 from the sensor 15 and compares it iteratively with the stored calibrated distances d₁₋₃ 1060. When the soundwaves are reflected by a parked vehicle 53 in any one or more of the discrete parking spaces 14₁₋₃, the distance d_{N} is always less than the respective calibrated distance d₁₋₃ corresponding to the parking space occupied by that vehicle: the body of the occupying vehicle occludes the sensor line of sight to, respectively, either the extremity 51, 52 of a bracketing space 14_{1,3} corresponding to a longest calibrated distance d_{1,2}, or the surface of the intermediate space 14_{1,3} corresponding to the shortest calibrated distance d₃, resulting in the detection of occupancy of a respective parking space.

At step 906, the microcontroller 41 encodes the detected occupancy of step 905 in a network message 1080, together with a timestamp. In a simple embodiment intended for least bandwidth usage, the encoding of detected occupancy data may include setting a bit flag corresponding to a respective discrete surface area 14₁₋₃, with one state corresponding to occupancy and the other to availability. The microcontroller 41 then commands the networking module 43 to communicate the network message 1080 to the connected remote recipient terminal at step 907.

A question is next asked at step 908, about whether the microcontroller 41 has received a network interrupt via the networking module 43. In ordinary use, the question of step 908 is answered negatively whereby, at step 909, the next instance of discrete surface area detection is parametered according to the default monitoring configuration data 1050, for instance with commanding an actuation of the motor 46 to rotate the oscillating arm 35 further along its arcuate trajectory or with commanding a switching of the next adjacent sensor 15_{N} in the array 61. Control proceeds to step 905 again, whereby the next detection of discrete surface areas 14₁₋₃ for occupancy is performed, and so and so forth.

Alternatively, the question of step 908 is answered positively, meaning that the microcontroller has received an inbound data communication from the remote data processing terminal, whereby a next question is asked at step 910, about whether the data communication is an update 1090 for the default monitoring configuration data 1050.

When the question of step 910 is answered positively, the microcontroller 41 overwrites the default monitoring configuration data 1050 in the memory 42 with the received updating data 1090, for instance faster or slower oscillation rate(s) and/or angular speed value(s) for the oscillating arm 35, faster or slower sensor switching rate(s) for the array 61, a lower or higher tolerance threshold value and/or a second threshold value. Control then proceeds to step 909 for the next instance of discrete surface area detection to be parametered according to the updated monitoring configuration data 1050.

When the question of step 910 is answered negatively however, the data communication may constitute any of a firmware update, a remote ad hoc maintenance access, a command to switch the apparatus off or some other data structure and/or command 911 similarly outside the primary function of detecting occupancy of surface areas 14₁₋₃. Control eventually proceeds either to step 902 for recalibrating the apparatus 30 if needed, or preferably to step 905 for resuming detection of surface area occupancy according to the loop constituted by steps 905 to 909.

With reference to FIGS. 11 and 12 now, an embodiment of a system according to the invention is shown, monitoring the first parking unit 10 of FIG. 3 or 6 and a second parking unit 110 through respective networked monitoring apparatuses 30, 130 that are operably connected with a remote data processing terminal 1100, which may be the same remote data processing terminal to which the apparatus 30, 60 of FIGS. 3 to 8 connects at step 904 as previously described.

In the example, the second vehicle parking unit 110 again comprises a row 12 of three on-street car parking spaces 14₄, 14₅, 14₆ as a further reserved section of the public highway 31 in an adjacent street. The environment includes a second pavement section 32 alongside the public highway 31 and a second street lighting fixture 33 extending upwardly from the second pavement section 32, which is located substantially mid-section of the intermediate parking space 14₅ in the row 12. The second apparatus 130 is secured to the second street fixture 33 at a level substantially proximate an end of the fixture distal the pavement 32.

Each of the first and second networked monitoring apparatuses 30, 130 is connected to the remote data processing terminal 1100 for bilateral data communication therebetween, through a Wide Area Network 1110, an example of which is the Internet 1110. A respective network connection 1120₁, 1120₂ is established to the WAN 1110 by the LPWAN module 43 of each networked monitoring apparatus 30, 130, whilst the data processing terminal 1100 establishes its own connection 1120₃ to the WAN 1110 through a local modem-router device 1221, to which it may be locally connected (1222) by wire or wirelessly.

A typical hardware architecture of the data processing terminal 1100 is shown in FIG. 12 in further detail, by way of non-limitative example. As skilled persons will readily understand, the hardware architecture of the terminal 1100 may vary to a great extent, but desirably comprises components designed for durability and redundancy of operation. The terminal 1100 is a computer configured with a data processing unit 1201, data outputting means such as video display unit (VDU) 1202, data inputting means such as HiD devices, commonly a keyboard 1203 and a pointing device (mouse) 1204, as well as the VDU 1202 itself if it is a touch screen display, and network data inputting/outputting means such as the wired or wireless network connection 1222 to the communication network 1110 via the router 1221, a magnetic data-carrying medium reader/writer 1206 and an optical data-carrying medium reader/writer 1207.

Within the data processing unit 1201, a central processing unit (CPU) 1208 provides task co-ordination and data processing functionality. Sets of instructions and data for the CPU 1208 are stored in memory means 1209 and a hard disk storage unit 1210 facilitates non-volatile storage of the instructions and the data. A network interface card (N IC) 1211 provides the interface to the modem-router 1221 by establishing the local connection 1222. A universal serial bus (USB) input/output interface 1212 facilitates connection to the keyboard and pointing devices 1203, 1204.

All of the above components are connected to a data input/output bus 1213, to which the magnetic data-carrying medium reader/writer 1206 and optical data-carrying medium reader/writer 1207 are also connected. A video adapter 1214 receives CPU instructions over the data bus 1213 for outputting processed data to the VDU 1202. All the components of data processing unit 1201 are powered by a power supply unit 1215, which receives electrical power from a local mains power source and transforms same according to component ratings and requirements.

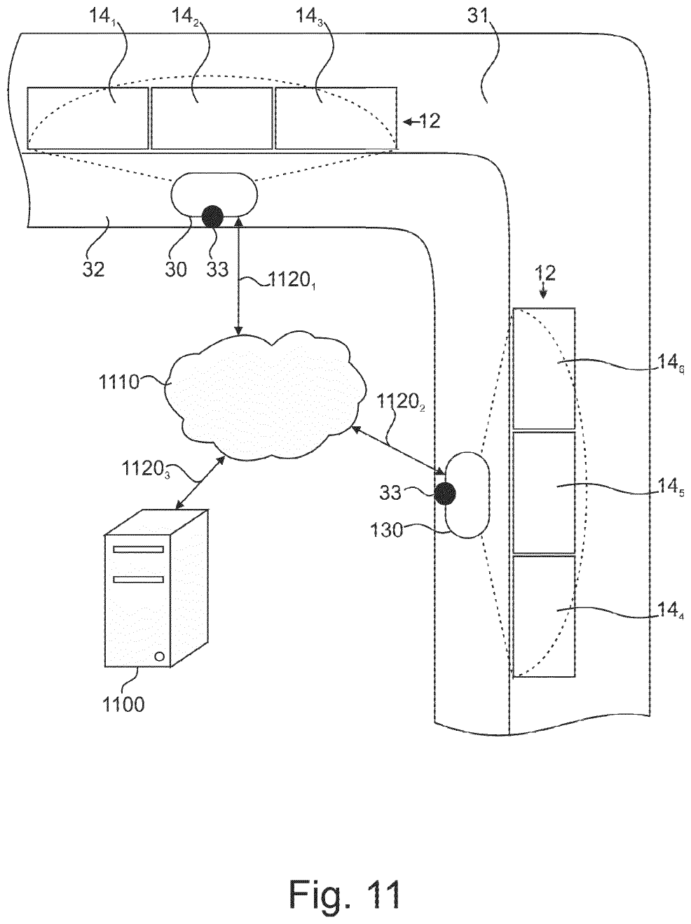

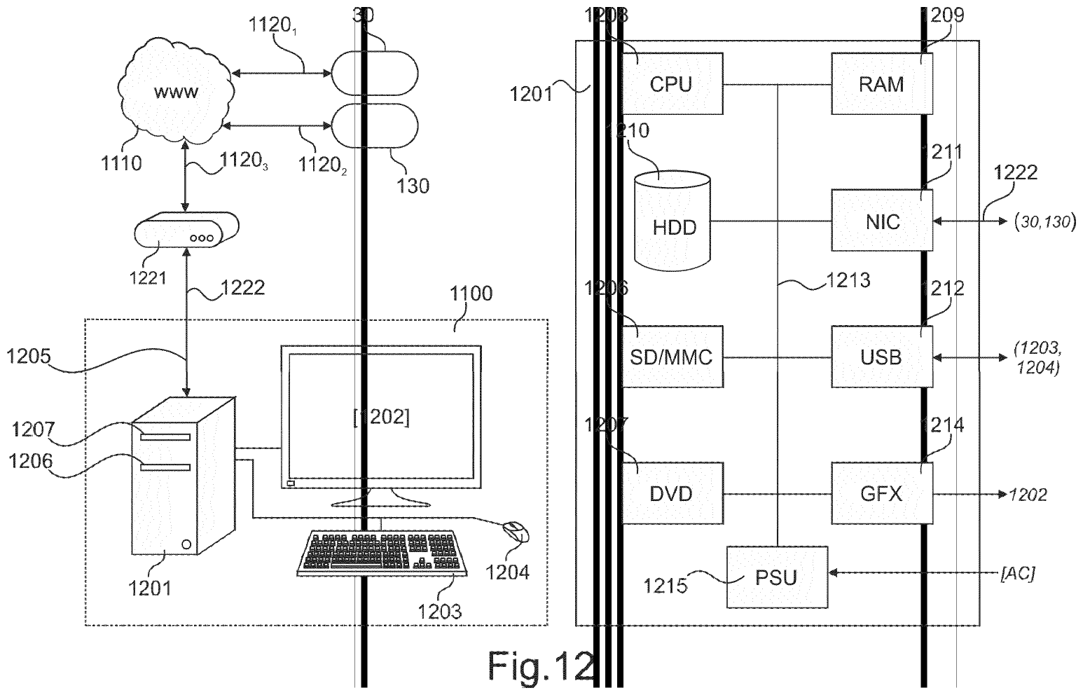

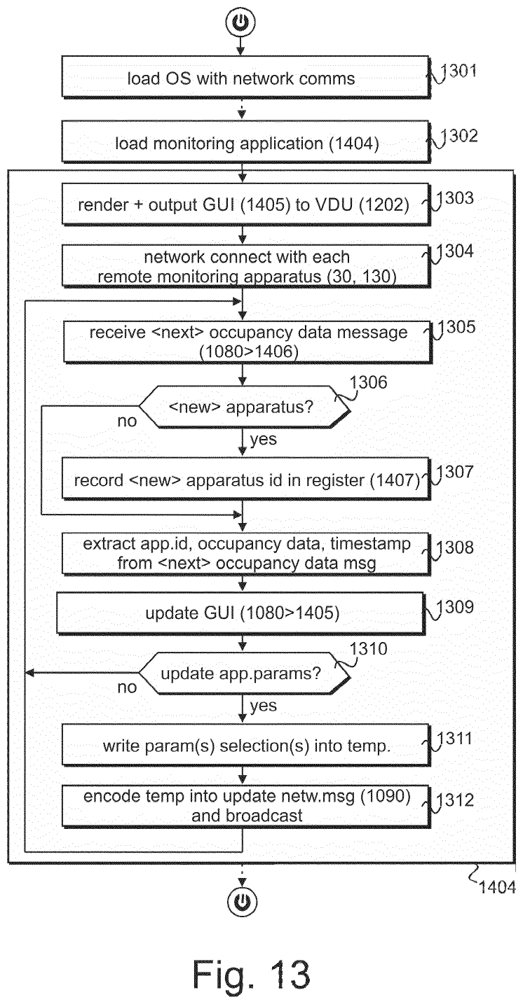

Within the respective contexts of the appartus and the system shown in and described with reference to FIGS. 3 to 12, the data processing method performed as a data processing logic processed by the terminal 1100 for monitoring occupancy across the vehicle parking unit(s) 10 and optionally 110, and the data structures involved are now described by reference to FIGS. 13 and 14. Data processing steps of the methodology are described as a discrete group of chronological data processing tasks repeated iteratively at runtime. It will be readily understood by the skilled person that such steps may be optimised and, where appropriate, processed substantially in parallel, as the architecture of the CPU 1201, and the basic instructions set and libraries for same allows.

After powering up the terminal 1100 conventionally, an operating system(iOS) 1401 is loaded in the memory 1209 and started locally at step 1301, including a set of communications subroutines 1402 for controlling and communicating data through the NIC module 1211. The startup step further loads one or more Application Programmer Interface(s) (API') 1403 for controlling and receiving data from the or each apparatus 30, 130.

A monitoring application 1404 is next loaded at step 1302, which configures the terminal 110 for interoperability with at least one remote apparatus 30 according to the invention, in the system of the example with two apparatuses 30, 130, and which instantiates a graphical user interface 1405 on the display 1202 at step 1303. The application 1404 then establishes a network connection across the WAN 1110 at step 1304, with each apparatus already registered with it for supplying occupancy data thereto, according to the principles described hereafter, and thus begins to receive respective network messages from one or more apparatuses, including registration requests sent by new apparatuses, and timestamped occupancy data as inbound network messages 1080 that are stored by the application in a FIFO buffer 1406 at step 1305.

Accordingly, a question is then asked at step 1306, about whether a new (or next) remote apparatus should be registered in the system, for instance or when an existing set of discrete surface areas 14_{7-N} is retrofitted for monitoring with an apparatus 30 secured proximate or adjancent thereto, or when a new set of discrete surface areas 14_{7-N} is provided for occupancy with an apparatus 30 secured proximate or adjancent thereto.

Whenever the question of step 1306 is answered positively, the application 1404 records the or each additional apparatus 30 into an apparatus register data structure 1407 with a unique and respective identifier at step 1307, for example the media access control (‘MAC’) address of the LPWAN 43 of that additional apparatus 30, and with a number of settable bit flags corresponding to the number of discrete surface area(s) 14_{1-N} monitored by that new apparatus after it has calibrated itself at step 904.

Subsequently, or when the question of step 1306 is answered negatively, the application 1404 processes the oldest network message encoding timestamped occupancy data still in the buffer 1406 at step 1308. In a simple embodiment, step 1308 comprises extracting the identifier MAC from the message header and matching it with a record in the apparatus register 1406 for authentication, extracting the detected occupancy data and the timestamp data from the message after authentication, and resolving the discrete surface area 14_{1-N} to which the detected occupancy data relates, by comparing the extracted occupancy data with the settable bit flags in the register 1406 corresponding to the authenticated apparatus.

At step 1309, the application 1404 then updates a representation of the resolved discrete surface area 14 to which the extracted detected occupancy data relates in the user interface 1405, e.g. red for occupied or green for available. In a still simpler embodiment dispensing with colour-coding, the application 1404 may just update two counters in the GUI 1405, respectively one for occupied parking places and other for occupied parking places, based on the extracted occupancy data if same relates a change from one state to the other for the resolved discrete surface area 14.

After updating the GUI 1405, a question is next asked at step 1310, about whether an input has been provided to update operational parameters of a remote monitoring apparatus. The application 1404 preferably stores the standard operational parameter data 1040 and the default monitoring configuration data 1050 for each apparatus 30, 130 recorded in the register 1407, and the GUI 1405 is preferably configured with a menu interface or the like for facilitating a user's consultation of this stored operational data 1040, 1050 and effecting one or more change selections therethrough. Such changes may for instance be desirable according to local area weather, e.g. when particularly inclement weather could impair the detection performance of apparatuses 30, 130 such that a higher frequency of detection steps 905 is desirable per unit of time for maintaining the accuracy of detected occupancy data.

Accordingly, whenever the question of step 1310 is answered positively, the application 1404 records such user selection(s) in a temporary data structure 1408 at step 1311, which it associates with one or more apparatuses 30, 130 recorded in the register 1407. Upon completing the one or more selections, at step 1312 the application encodes the temporary data structure1408 as an outbound update network message 1090 and communicates it across the WAN 1110 to the associated one or more apparatuses 30, 130.

Alternatively, when the question of step 1310 is answered negatively, control returns to step 1305 for storing the <next>inbound network message 1080 in the FIFO buffer 1406, then processing it at step 1308 and updating the GUI 1405 at step 1309, and so on and so forth.

The application 1404 thus implements a remote monitoring of the discrete surface areas 14_{1-N} in quasi- or actual real-time, subject to the data processing capacities of the CPU 1208 and the latency inherent to the entire data connection 1120_{1,2}-1120₃ between the terminal 1100 and a monitoring apparatus 30, 130. The skilled person will easily understand that the application 1404 may be implemented without a buffer 1406 and the buffering step 1305, and initiate the processing of steps 1308 and 1309 as soon as the connection of step 1304 is established with at least one apparatus, then continue to process same as appartus network messages 1080 are received, all in parallel with the remaining steps of the method.

Subject still to the data processing capacities of the CPU 1208, the skilled person will easily understand that the application 1404 may be stored in the memory 42 and processed by the microcontroller 41 runs of an apparatus 30,60 without the processing overhead of renedering and outputting a GUI 1405. In such an embodiment, the or each further apparatus 130 with lesser data processing capacities in the system establishes the connection of step 904 with the apparatus 30, 60 processing the application 1404 by way of the remote terminal 1100.

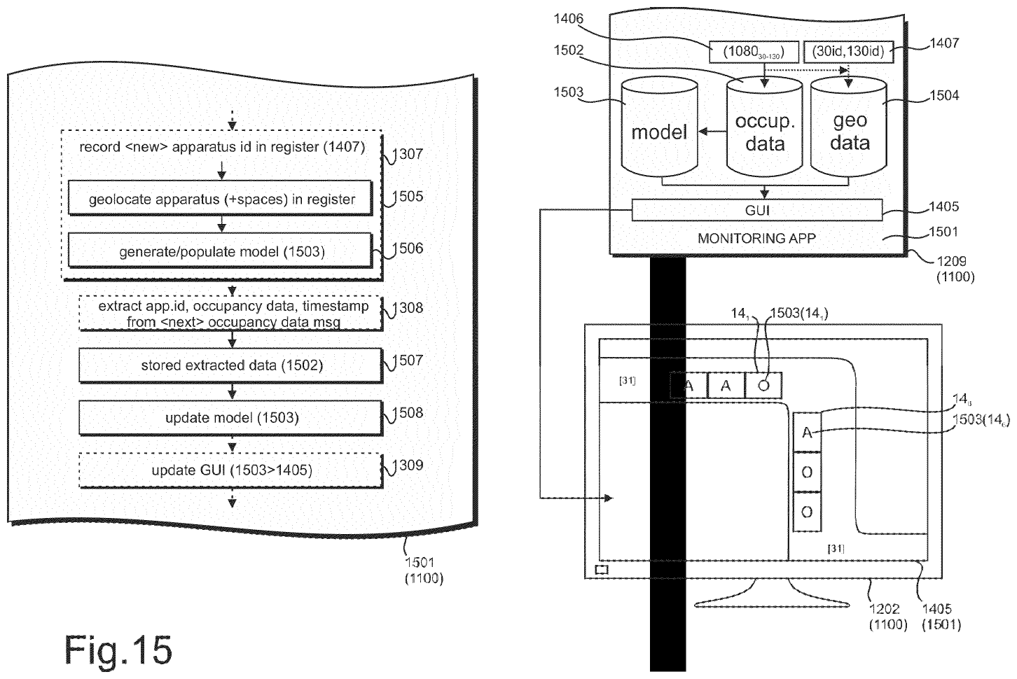

With reference to FIG. 15 now, a second embodiment of a monitoring system is shown, wherein the functionality of the system of FIGS. 11 to 14 is augmented through additionally storing and geolocating the occupancy data detected by the or each monitoring apparatus 30,60,130 in the system. The monitoring application 1501 of this embodiment includes further data structures stored in the memory 209, namely a data store 1502 of the timestamped occupancy data, a digital model 1503 of the totality of the discrete parking spaces 14₁₋₆ monitored by the registered monitoring apparatuses 30, 130, and optionally a data store 1504 of geographical or similar mapping data corresponding describing the physical environement in which parkings spaces 14₁₋₆, in the example the network of publich highways 31.

The data store 1502 may simply consist of a table or database structure aggregating timestamped occupancy data, which is populated as timestamped occupancy data is extracted from each further network message 1080 processed at step 1308. The digital model 1503 references each discrete parking space 14₁₋₆ monitored by the registered monitoring apparatuses 30, 130 and its respective occupancy status as last determined. The model may thus simply consist of a table or database structure populated with a new record as each additional bit flag is first recorded in the apparatus register 1407, and wherein each record is updated according to the occupancy status of the corresponding bit flag determined from the extraction of step 1308. The model may further cross-reference each discrete surface area with one or more respective geographical coordinate(s) for enhanced functionality.

In the above, the geographical data store 1504 is described as optional, because the respective mapping data locating each monitoring apparatus 30, 130 of the system within the geographical area encompassing all monitored parking spaces, may be encoded in the register 1407 at the step 1307 of registering a new apparatus therein, either manually by a user at terminal 1100, or automatically based on geographical data encoded in apparatus network messages. In particular, depending upon its components and operational configuration, an apparatus may be capable of self-geolocation, either through an onboard GPS module, or wireless signal strength-based estimation, or some other triangulation-based principle, and to encode this self-determined geographical data in network messages 1080 addressed to the terminal 1100. Usefully, any such apparatus may be further capable of geolocating each discrete surface area 14_{1-N} which it monitors, by computing the respective and corresponding location based on the calibrated distances d₁₋₃ and the angle of the or each sensor's aperture at the point of surface detection in time, readily derivable from the motor shaft position along the arcuate trajectory of the single-sensor embodiment 30, or which sensor is switched in the array-of-sensors embodiment 60.

The monitoring application 1501 of this embodiment includes further data processing steps, respectively as sub-steps of the apparatus registration step 1307 and after the occupancy data extraction step 1308. A first sub-step 1505 comprises the geolocation of at least the apparatus 30, optionally also each discrete surface area 14_{1-N} monitored by same at the time of registering that apparatus in the register 1407 at step 1307. A second sub-step 1506 immediately following step comprises, on a first iteration of the processing cycle, generating the model 1503 or, on a subsequent iteration of the processing cycle, populating the model 1503 with a record for each discrete surface area 14_{1-N} associated with the newly-registered apparatus.

Intermediate the steps of extracting 1308 and GUI updating 1309, a next sub-step 1507 comprises storing the extracted occupancy data with respective time stamp data in the data store 1502 and, immediately thereafter at step 1508, updating the record in the model 1503 corresponding to the discrete surface area 14 for which occupancy data was last extracted.

In use, the monitoring application1501 renders the digital model 1503 in the user interface 1405 on the display 1202 by way of updating the GUI at step 1309, preferably augmented with geographical mapping data, for instance extracted from the geographical data store 1504, in order to facilitate a user's observation of occupancy status. As network messages 1080 encoding occupancy status for discrete parking spaces are iteratively received and processed through steps 1305 to 1310 cycling, the model 1503 is correspondingly updated as fast as the application 1801 cycles, likewise the GUI 1405 rendered from the model.

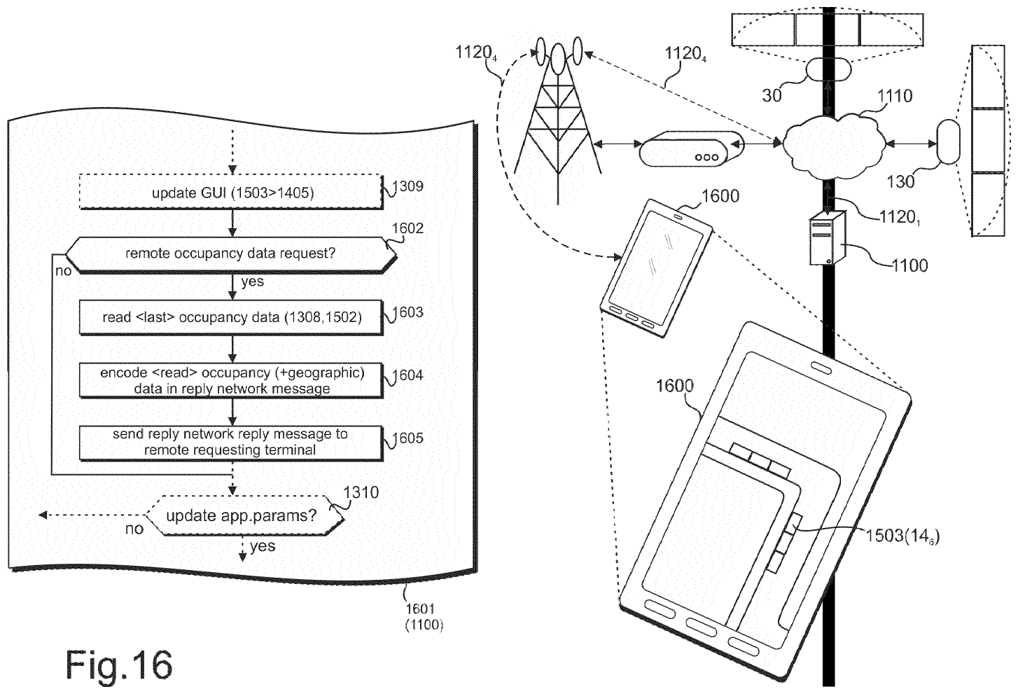

With reference to FIG. 16 now, a third embodiment of a monitoring system is shown, wherein the functionality of the system of either FIGS. 11 to 14 or FIG. 15 is augmented through distributing occupancy data to requesting remote user devices. In this embodiment, the terminal 1100 is configured to permit, process and respond to inbound data requests from remote devices other than monitoring apparatuses, for example a mobile communication device 1600 of a vehicle driver requiring information about parking spaces, in the context of the examples described herein.

Each such mobile communication device 1600 may access the terminal 1100 through the WAN 1110 via a respective network connection 1120₄ established conventionally across constitutent parts of a mobile communication network, e.g. a relay or base station closest to the mobile device 1600 and an associated gateway, wherein access to the terminal 1100 may be subjected to user login or other type of authentication.

The monitoring application 1601 of this embodiment includes further data structures stored in the memory 209, namely a request FIFO buffer similar to the FIFO buffer 1406 but dedicated to data requests received from remote user devices 1600_{1-N}, and outbound network messages encoding respective responses to the data requests, wherein each such response comprises at least occupancy data as last extracted at step 1308, optionally geolocated if the response is generated from the model 1503 in a relevant embodiment.

The monitoring application 1601 of this embodiment includes further data processing steps intermediate the local GUI updating step 1309 and the monitoring parameter updating subroutine of steps 1310-1312, beginning with a question at step 1602, about whether there is an outstanding occupancy data request in the request buffer. When the question is answered positively then at step 1603, the monitoring application 1601 retrieves the current occupancy status, either as last last extracted at the preceding instance of step 1308 or as last written to the model 1503 at step 1510. The monitoring application 1601 next encodes the retrieved occupancy status in a respective network message to the user device 1600 associated with that request at step 1604, before flushing the request from the request buffer and sending the message to the requesting terminal 1600 at step 1605. Alternatively, the question of step 1602 is answered negatively, whereby control proceeds directly to the monitoring parameter updating subroutine of steps 1310-1312 instead, and as before described.

For the convenience of the requesting device user, and as illustrated in the FIG. 16, the encoding of step 1604 may further include respective geographical or mapping data for each parking space, the respective occupancy data of which is encoded in the reply message, retrieved from the model 1503, the geographical data store 1504 or the apparatus register 1407 depending on the embodiment.

Likewise a variant of this embodiment well within the implementation capacity of the skilled person may usefully allows a vehicle driver using a device 1600 to specify a preferred location parameter in the occupancy data request, to restrict the geographical scope of the query and, therefore, the corresponding data processing requirements at the terminal 1100. Subject to the data processing capacities of the terminal 1100 and the latency inherent to the network connection 1120₄ therewith, variants of such an embodiment may be augmented with a realtime notification capacity, which tracks the occupancy state of parking spaces 14 at the preferred location, and communicates realtime updates to the device 1600 so long as the network connection 1120₄ is maintained, usefully advising the vehicle driver if an intended parking space should become occupied before the driver reaches it, likewise occupied parking space becoming available nearby.

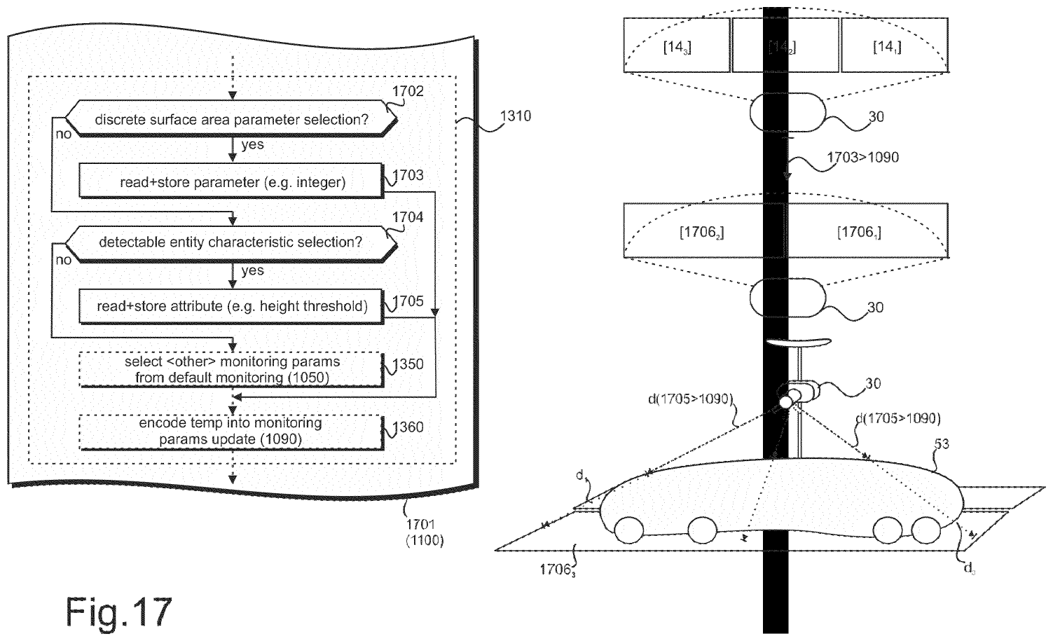

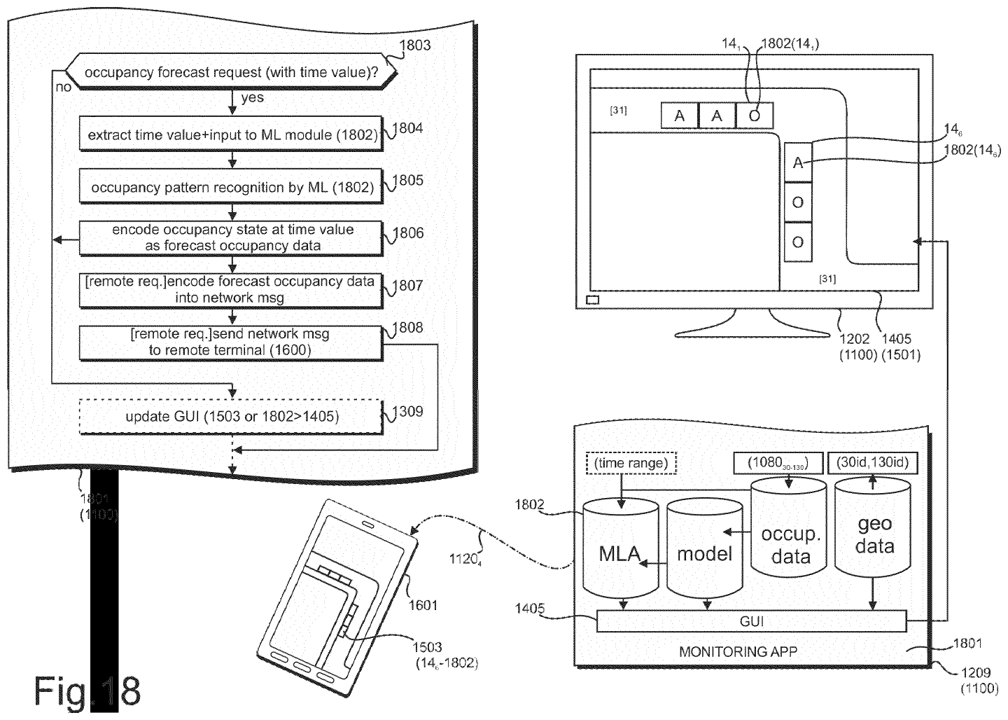

With reference to FIG. 17 now, a fourth embodiment of a monitoring system is shown, wherein the functionality of the previously-described systems is augmented through modifying the operational parameters 1050 under which one or more monitoring apparatuses 30, 130 detect occupancy in the system, in particular modifying one or more parameters of the discrete surface area under monitoring and/or one or more detectable characteristic of entities occupying those areas.

The monitoring application 1701 of this embodiment includes further data processing steps, as additional sub-steps 1702 to 1705 of the operational parameters recording of step 1311, supplementary to the step 1350 of selecting alternative monitoring parameters from the standard data 1050 as previously described with reference to FIG. 13, and wherein the storing of selection(s) in a temporary data structure 1408, the association of selection(s) with one or more apparatuses 30, 130 recorded in the register 1407, the encoding of the temporary data structure1408 as an outbound update network message 1090 at step 1360 and its communication across the WAN 1110 to the associated one or more apparatuses 30, 130 at step 1312 are all likewise inherited. In this embodiment, the selecting is further made accessible to requesting user terminals 1601 under the same principles of connectivity and interoperability as described with reference to FIG. 16.

Selections in this embodiment may include a parking space size or length 1702 by way of discrete surface area parameter, and a vehicle size or height 1703 by way of detectable entity characteristic. Accordingly, upon detecting an input to update operational parameters of a remote monitoring apparatus at step 1310, either through interaction from a user of terminal 1100 or, in this embodiment, a modyfing request from a remote device 1601, a question is asked at step 1702, about whether the update relates to a parameter of a discrete surface area.

When the question of step 1702 is answered positively, at step 1703 the monitoring application 1701 reads and records the modifier in the temporary data structure, in the example an integer bounded by the total number of parking spaces 14 available in a row 12, i.e. which cannot be higher than 3 in the example rows shown in the Figures, wherein 2 is representative of two parking spaces 1706_{1,2} each comprised of an end parking space 14_{1,3} plus half of the central parking space 14₂ in the row, and 1 is representative of a single parking space 1706₃ comprising all 3 discrete spaces 14_{1,2,3}.

Alternatively the question of step 1702 is answered negatively and a second question is asked at step 1704, about whether the update relates to a detectable characteristic of an entity. When the question of step 1703 is answered positively, at step 1704 the monitoring application 1701 reads and records the modifier in the temporary data structure, in the example an integer corresponding to a detectable vehicle height representative of an upper vehicle body surface, the valid input of which is conditional to the integer being higher than the standard value recorded in the default monitoring configuration data 1050.

Alternatively the question of step 1704 is answered negatively and control proceeds to step 1350 for selecting alternative monitoring parameters from the standard data 1050, as previously described. Upon recording a modifier in the temporary data structure either at step 1703 or step 1705, or at step 1350, the application 1701 then encodes the temporary data structure1408 as an outbound update network message 1090 at step 1360 as previously described.

This embodiment usefully allows the user of terminal 1100 to repurpose rows 12 of parking spaces 14_{1-N} monitored by the system in real-time for various types of vehicles, according to geographical and/or horlogical preferences, special occasions and more, for example alternating between more parking spaces 14_{1-N} for passenger vehicles during working hours, and less parking spaces 1706_{1-N} for longer goods vehicles outisde of working hours. Likewise a variant of this embodiment well within the implementation capacity of the skilled person usefully allows a vehicle driver using a device 1600 to specify a parking space search parameter based on either characteristics of the vehicle in terms of length or height.

With reference to FIG. 18 now, a fifth embodiment of a monitoring system is shown, wherein the functionality of systems incorporating the storing and geolocating of occupancy data as previously described, is augmented through occupancy pattern detection and occupancy forecasting based on such detected patterns.

The monitoring application 1801 of this embodiment include a further data structure stored in the memory 209, namely a machine learning module 1802 operably interfaced with the occupancy data store 1502 as a first input, with the model 1503 as a second input, and optionally with the geographical data store 1504 if it is provided in the embodiment as a third input. The monitoring application 1801 remains configured to update its GUI from the model 1503 which incorporates the output of the machine learning module 1802, and optionally also from the geographical data store 1504 if it is provided in the embodiment.

The monitoring application 1801 of this embodiment includes further data processing steps, some distinct from the main data processing loop described with reference to FIG. 13, others intermediate the occupancy data extraction of step 1308 and the local GUI updating of step 1309. In particular, the monitoring application 1801 includes a step 1803 of initially training the machine learning module 1802 to detect patterns of occupancy in the timestamped occupancy data stored. This training step 1801 should preferably be performed only after the data store of occupany data 1502 has reached a non-trivial volume of data, corresponding to a similarly non-trivial period of time during which the occupancy of parking spaces monitored by the whole system is deemed to have varied sufficiently for patterns to become discernible, for example 24 hours after the system's initialisation. This training step 1801 should then be continuously performed from this point forward, in parallel to the main data processing loop, as further occupancy data gets detected and stored over time, to refine the detection of occupancy patterns and account for any degree of pattern shifting.

Further steps of the monitoring application 1801 are processed subsequently to training the machine learning module 1802 at least once, and begin with a question at step 803 about whether the monitoring application 1801 has received an occupancy forecast request, either locally at the terminal 1100 or in a remote data request from a user device 1600, wherein the valid input or submission of a request is conditional upon providing a forecast time value, for instance corresponding to an estmated time of arrival at a destination with parking spaces 14_{1-N} monitored by the system. Question 1803 is preferably asked before updating the GUI 1405 at step 1309 whereby, when the question is answered negatively, the GUI 1405 is updated directly from the model 1503 incorporating actually detected occupancy data at step 1309 as previously described.

Alternatively, when the question of step 1803 is answered posiextracttively, the monitoring application 1801 extracts the forecast time value data from the request and inputs it to the machine learning module 1802 as a forecast parameterising value at step 1804. The machine learning module then processes the pattern recognition algorithm over the period ended at the forecast time value and outputs an occupancy state for one or more parking spaces 14_{1-N} as of the forecast time value at step 1805. In a simple implementation, the detecting comprises computing an occupancy frequency for each discrete surface area in the model 1503, over the period of time elapsed between the first occupancy data record with the first timestamp and the last record with the last timestamp in the datastore 1502 at the time of receiving the forecast time value of step 1802, and the forecasting comprises replicating the detected occupancy frequency pro-rata over the period of time elapsed between the occupancy data record with the last timestamp and the forecast time value.

At step 1806, the monitoring application 1801 next encodes the output occupancy state of step 1805 as forecast occupancy data. When the forecast request is local, the monitoring application 1801 pushes the forecast occupancy data to the GUI 1405 at the next instance of the GUI updating step 1309. Alternatively, when the forecast request is remote, the monitoring application 1801 encodes the forecast occupancy data in a respective network message to the user device 1600 associated with that forecast request at step 1807, before sending the message to the requesting terminal 1600 at step 1808.

For the convenience of the requesting device user, and as illustrated in FIG. 18, the encoding of step 1807 may again further include respective geographical or mapping data for each parking space, the respective forecast occupancy data of which is encoded in the reply message.

Many further embodiments are considered, which all implement the principles disclosed and described herein.

With reference to the distance-based detection performed by ultrasonic sensors 15 of the example, the skilled person will easily conceive of alternative units of detection with the same detectors as described, or when alternative types of sensors are used, singularly or in combination. The interval between sucessive detections at step 905 may be configured to be sufficiently high, for computing a shape and/or volume of the monitored entity occupying the discrete surface area from the set of discrete distances detected across the intervals. In another example, in a context of livestock monitoring on a farm, the ultrasonic sensor 15 of the apparatus 30 may used in conjunction with a second infrared or thermal sensor mounted to the oscillating arm 35, apt to detect body heat of cattle. In a further example, in a context of goods container monitoring, a combination of ultrasonic and optical (‘CCD’) sensors may be used in the array 61 to implement dual occupancy detection and security monitoring functions. The opportunities for mixing modalities of monitoring in embodiments of the apparatus are considered plentiful and advantageous.

The invention is not limited to the embodiments hereinbefore described but may be varied in both construction and detail. For example, it will be readily understood by skilled persons that the inventive principles disclosed herein in relation to hardware architectures and/or components and/or their arrangement may be permanently integrated into the standard configuration of a micro-processor through relevant manufacturing techniques.

In the specification the terms “comprise, comprises, comprised and comprising” or any variation thereof and the terms “include, includes, included and including” or any variation thereof are considered to be totally interchangeable and they should all be afforded the widest possible interpretation and vice versa.

1. A networked monitoring apparatus, comprising
at least one sensor;
a wireless networking module;
data processing means operably connected to the or each sensor and to the wireless networking module, and configured
to periodically monitor each of a plurality of discrete surface areas proximate or adjacent the apparatus and detect a respective occupancy state thereof by a respective entity with the or each sensor;
to determine a start and/or end of occupancy state by each respective entity, and
to communicate respective occupancy state data to at least one remote data processing terminal with the wireless networking module;
a power source operably connected to the data processing means, the wireless networking module and the or each sensor; and
a housing for shielding the wireless networking module, the or each sensor, the data processing means and the power source from environmental conditions, attachable to at least one mounting point adjacent the plurality of discrete surface areas.

2. An apparatus according to claim 1,
wherein the at least one sensor is secured to an oscillating mechanism , the data processing means is operably connected to the oscillating mechanism and is further configured to control an oscillating frequency and/or angular speed thereof; or
wherein a plurality of sensors is arranged in an array within the housing, the data processing means is operably connected to the array and further configured to control a monitoring aperture thereof.

3. An apparatus according to claim 1, wherein the or each sensor is selected from the group comprising ultrasonic, infrared, microwave, thermal and optical sensors; and optionally
wherein each sensor of a plurality thereof in the apparatus, is of a different type in the group relative to the or each other.

4. An apparatus according to claim 1, wherein at least one detectable characteristic of entities is user-selectable, and wherein the data processing means is further configured to receive, through the wireless module, the or each detectable characteristic as a monitoring parameter.

5. An apparatus according to claim 1, wherein a parameter of each discrete surface area is user-selectable, and wherein the data processing means is further configured to receive, through the wireless module, the or each parameter from the remote data processing terminal as a monitoring parameter.

6. An apparatus according to of claim 1, wherein the at least one remote data processing terminal is another apparatus according to claim 1.

7. A distributed surface monitoring system, comprising
at least one networked monitoring apparatus according to claim 1 located adjacent a first plurality of discrete surface areas;
optionally a second networked monitoring apparatus according to claim 1 located adjacent a second plurality of discrete surface areas; and
at least one data processing terminal remote from the or each apparatus and operably in data communication therewith across at least one network.

8. A system according to claim 7, further comprising
storing means for storing a model of each discrete surface area; and
geolocating means for associating occupancy state data that is received from the one or more apparatuses with each discrete surface area in the model, substantially in real time, and for receiving, processing and responding with detected occupancy state data, to a data request from the or each data processing terminal.

9. A system according to claim 8, wherein the or each data request comprises a detectable characteristic of an entity and wherein the geolocating means is further configured to match the detectable characteristic with a parameter of one or more discrete surface areas.

10. A system according to claim 7, wherein the storing means is further for storing occupancy state data of each discrete surface area;
the system further comprising analysing means for processing the stored and associated occupancy state data, to detect patterns of occupancy state across discrete surface areas in the model over time and to predict occupancy states of discrete surface areas based on detected patterns.

11. A system according to claim 10, wherein the geolocating means is further configured to respond to the data request with geographical data representative of at least one discrete surface area that is predicted to become available for occupancy according to its predicted occupancy state data.

12. A method of monitoring parking surface occupancy by vehicles, comprising the steps of
locating at least a first apparatus comprising a networking module and at least one sensor proximate or adjacent a first plurality of parking spaces;
periodically monitoring each parking space with the or each sensor;
detecting a respective occupancy state of each parking space by a respective vehicle;
determining a start and/or end of occupancy state by each respective vehicle;
establishing a first network connection between the at least first apparatus and at least one remote data processing terminal with the networking module;
communicating occupancy state data to the or each remote data processing terminal.

13. A method according to claim 12, comprising the further step of locating a second apparatus comprising a networking module and at least one sensor proximate or adjacent a second plurality of parking spaces.

14. A method according to claim 12, comprising the further step of establishing a data communication link between each apparatus, over either the first network connection or a second ad hoc network connection.

15. A method according to claim 12,
comprising the further step of securing the sensor to an oscillating mechanism; or
comprising the further step of arranging each sensor within an array defining a detecting aperture; and
wherein the step of monitoring further comprises controlling a frequency of mechanism oscillation, alternatively a frequency of sensor switching, according to one or more selected from the group comprising a chronological parameter, an environmental parameter and an operational parameter of the first apparatus.

16. A method according to claim 12, comprising the further steps of
selecting a detectable vehicle characteristic either at the data processing terminal;
communicating the selected detectable vehicle characteristic to the or each apparatus;
setting the selected detectable vehicle characteristic as a monitoring parameter.

17. A method according to claim 12, comprising the further steps of
selecting a parameter of a or each parking space either at the data processing terminal;
communicating the selected parking space parameter to the or each apparatus;
setting the selected parking space parameter as a monitoring parameter.

18. A method according to claim 16, comprising the further steps of
receiving a data request including a detectable vehicle characteristic, alternatively a parking space parameter, from the data processing terminal;
matching the data request with detected occupancy state data; and
responding to the data processing terminal request with the matched occupancy state data.

19. A method according to claim 12, comprising the further steps of
storing a model of each plurality of parking spaces; and
geo-locating occupancy state data that is received from each apparatus with the corresponding parking space in the model, substantially in real time.

20. A method according to claim 19, comprising the further steps of
storing occupancy state data of each parking space;
detecting patterns of occupancy state across parking spaces in the model over time;
predicting occupancy states of parking space based on detected patterns; and
communicating geographical data to the data processing terminal, representative of at least one parking space predicted to become available for occupancy according to its predicted occupancy state data.

21. (canceled)
